(19) United States
(12) Patent Application Publication
(10) Pub. No.: US 2014/0341265 A1
(43) Pub. Date: Nov. 20, 2014

(54) METHOD FOR SUBRATE DETECTION IN BANDWIDTH CONSTRAINED COMMUNICATION SYSTEMS

(71) Applicants: Nikola ALIC, La Jolla, CA (US); Stojan RADIC, San Diego, CA (US)

(72) Inventors: Nikola ALIC, La Jolla, CA (US); Stojan RADIC, San Diego, CA (US)

(21) Appl. No.: 14/204,453

(22) Filed: Mar. 11, 2014

Related U.S. Application Data
(60) Provisional application No. 61/776,656, filed on Mar. 11, 2013.

(51) Int. Cl. H04L 7/00; H04L 25/03

(52) U.S. Cl. CPC H04L 7/0087; H04L 25/03828
USPC 375/232; 375/355

(57) ABSTRACT

The present invention relates to utilization of sampling rate at the receiver that is below the symbol rate of a bandwidth constrained communication system. Furthermore, if the appropriate up-sampling technique is used, the method avails full retrieval of the information from the under sampled received signal.

### CROSS-REFERENCE TO RELATED APPLICATIONS

This application claims the benefit of U.S. Provisional Patent Application Ser. No. 61/776,656 by Nikola Alic and Stojan Radic, entitled “A Method for Subrate Detection in Bandwidth Constrained Communication Systems,” and filed on Mar. 11, 2013, the contents of which are incorporated herein in their entirety by this reference.

### FIELD OF THE INVENTION

The present invention relates generally to communication systems and more particularly to subrate, i.e. below the symbol rate detection in communication systems. The method is of particular interest for bandwidth constrained, or narrowly filtered communication systems.

### BACKGROUND OF THE INVENTION

Digital communication systems rely on sampling of continuous information—bearing waveforms at the receiving end of the link. In particular, the underlying transmitted information is retrieved/estimated from those samples. Furthermore, in the most common realization, one or more samples per symbol slot are taken, which become both a significant technological challenge, as well as a power demanding part of the system, especially so for communications operating at speeds surpassing mega-bit per second speeds. Consequently, the existing solutions fail to meet the industry needs since they result in overly intricate, and thus highly power hungry solutions for the sampling block.

Currently there are a number of solutions for detection in communication systems. Some of these solutions attempt to sample the incoming continuous information-bearing waveforms, but these solutions fail to meet the needs of the industry at high data rate links owing to the challenging requirements as to the high rate, or high bandwidth sampling. Other solutions attempt to retrieve the information by oversampling, i.e. sampling at a rate higher (e.g. usually double) of the transmitted symbol rate, but these solutions are similarly unable to meet the needs of the industry because since they result in excessively power hungry solutions.

Sampling rate is a critical practical concern in communication systems realization. In fact, a slower sampling rate translates to lower receiver and system overall power dissipation as well as easier practical implementation. Consequently, there currently exists a clear need in the industry for reduced rate sampled receivers. Consequently, it would be desirable to have an apparatus that is capable of taking advantage of lower rate sampling (i.e. lower than the symbol rate) which/that is altogether uncompromising about the system performance and is capable of retrieving the full information. Furthermore, it would also be desirable to have an apparatus that is characterized by lower power consumption. Still further, it would be desirable to have an apparatus that can be realized even at higher symbol rates. In summary, there currently exists a need in the industry for a composition that is capable of sub-rate sampling that is all the while capable of providing adequate system performance at high transmission speeds.

### SUMMARY OF THE INVENTION

The present invention advantageously fills the aforementioned deficiencies by enabling a sub-rate sampling which provides an easy transition and limited power dissipation in high speed communication systems.

The present invention is a method for communication receiver design that relies on a sampling rate that is lower than the transmitted symbol rate and which consists of the following steps: (1) an under-sampling (i.e. sampling at a rate that is lower than the transmission symbol rate) at the receiver (2) perform samples' interpolation, relying on digital signal processing and that up to at least the symbol rate; 3) pass on the up-sampled information to the remainder of the communication system detection chain.

The present invention may also consist of varying sampling rate, depending on channel condition.

The present invention method is unique when compared with other known processes and solutions in that it: (1) allows detection at the transmitted symbol rate of information, while relying on a lower sampling rate at the receiving end of the system; and (2) allows lower power dissipation sampling process as compared to the existing solutions.

As far as the structure present invention is unique in that it is different from other known processes or solutions. More specifically, the present invention owes its uniqueness to the fact that it adds the interpolation step in order to attain the full sampling rate (i.e. at the transmitted symbol rate, or higher), instead of utilizing a higher rate sampling device.

Among other things, it is an objective of the present invention to provide ability for full information retrieval from under-sampled waveforms in bandwidth constrained communication systems that does not suffer from any of the problems or deficiencies associated with prior solutions.

It is still further an object of the present invention to simplify construction of receivers in high speed communication systems.

Further still, it is an object of the present invention to reduce power consumption and complexity associated with samplers in digital communication systems.

### BRIEF DESCRIPTION OF THE DRAWINGS

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

FIG. 1 shows a general communication system schematic.

FIG. 2 shows a flow diagram of an up-sampling approach example.

FIG. 3 shows an illustrative up-sampling result.

### DETAILED DESCRIPTION OF THE INVENTION

The present invention is directed at enabling receiver design in bandwidth constrained communication systems operating at a rate that is lower than the transmitted symbol rate.

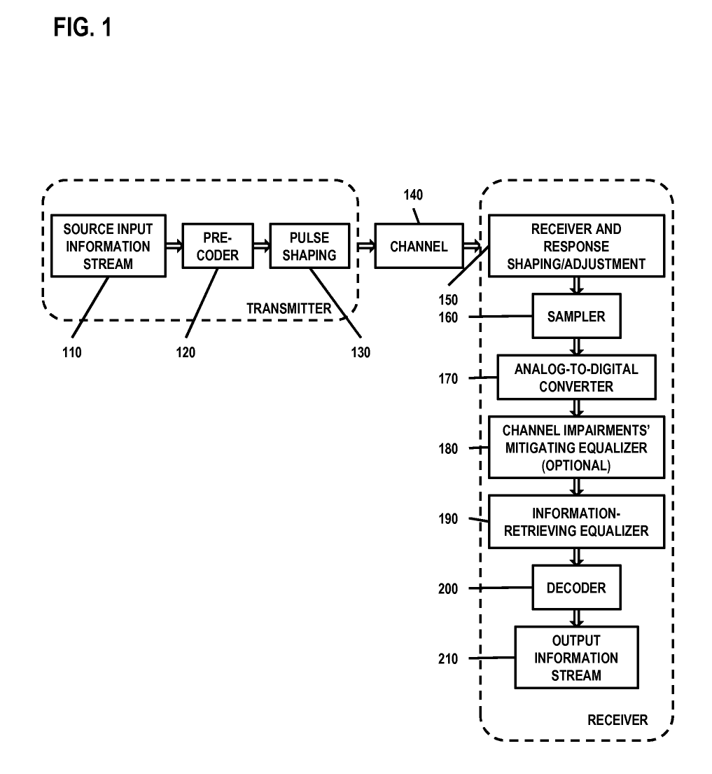

In the preferred embodiment of the invention, in a bandwidth constrained communication system, the transmitted information bearing waveforms are sampled at the rate that is lower than the symbol rate, and with an aid of an analog-to-digital converter are discretized and converted to a finite set of values. In the next step, as shown in FIG. 1 the samples are interpolated in the following manner: first, a, length—permitting, Fast (or, alternatively discrete) Fourier Transform of a block of directly obtained samples is performed; secondly, the thus obtained set of samples, in the Fourier domain, are padded with zero values, above the highest frequency content in the Fourier transform domain (i.e. obtained from the original set of samples). The number of added (i.e. padded) zeros is determined by the desired level (or a ratio) of up-sampling, with respect to the length of the originally obtained (and transformed) set of samples and is equal to the differential between the length of the original block of samples, and that after oversampling. As an example, assuming the original samples set having a length of 100 values, and the intended oversampling rate being 50% higher than that of the original set of samples, the length of the zero-pad is 50. Next, the zero-padded version of the Fourier domain sample set is inverse—Fourier transformed, arriving at the up-sampled version of the received signal that is conveyed to the remaining part of the processing/detection chain in the receiver.

The present invention may also have one or more of the following: In one embodiment, the up-sampling in the present invention can be realized based on Fast or Discrete Fourier Transform interpolation. Alternatively it can be realized by spline interpolation. In another instance, the invention can be deployed by an embodiment of polynomial interpolation. As a further example, the up-sampling can be realized by a wavelet-transform, or similar interpolation. In yet another embodiment, the interpolation can be realized by means of look-up tables. The latter interpolation can be applied directly, or as a part of the Fourier, wavelet, or a similar transformation step used as a part of interpolation. In a further embodiment the same effect of up-sampling can be realized by a proper weighted interpolation of the samples, taking advantage of any of, but not limited to the interpolation techniques, mentioned above. In an additional instance of the invention, the under-sampled set of samples need not be up-sampled, or interpolated, in which case the equalization structure, following the sampling and analog-to-digital converter operates at a higher level symbol alphabet, or, alternatively a more complex structure than that availed by oversampling, or interpolation.

Referring to the figures, FIG. 1 shows a general communication system block diagram. In general a communication system comprises of a transmitter, channel and a receiver blocks. Within the transmitter, the following parts are discernible: Input information stream (110), a pre-coder (120), as well as the pulse-shaping block (130), responsible for shaping of information—bearing waveforms that are transferred through the transmission channel. The receiver, on the other hand, comprises: a receiving filter (150), a sampler (160), an analog-to-digital converter (170), a channel impairments' mitigating equalizer (180), an information—retrieving equalizer (190) whose operation the present invention is primarily concerned with, a decoder (200), concluding with an output information stream (210).

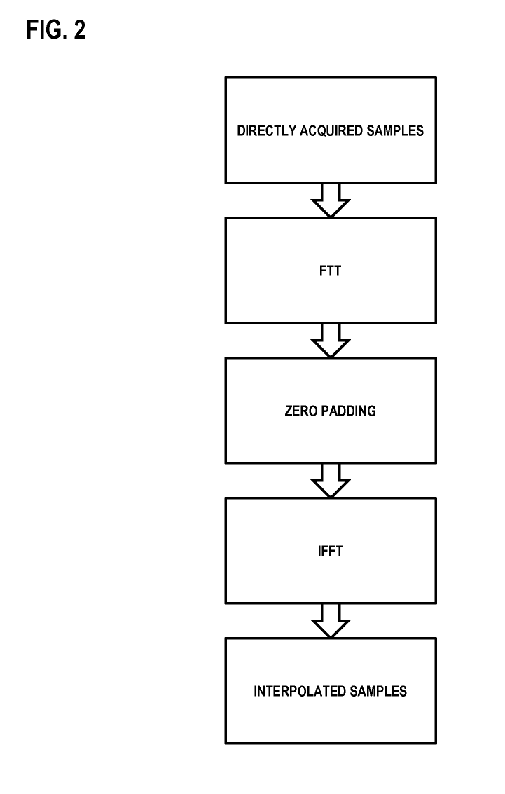

FIG. 2 shows an exemplary processing flow diagram of a sub-rate receiver in which the up-sampling is performed by means of the Fourier transform interpolation: the directly acquired samples, i.e. from a sampler operating at a rate that is lower than the transmitted symbol rate are discrete-Fourier transformed, after which the resulting Fourier domain samples collection is appropriately zero-padded; finally the zero-padded samples' collection is inverse Fourier transformed, yielding the sought after up sampled version of the signal that is subsequently passed to the remaining part of the receiver processing chain, shown in FIG. 1.

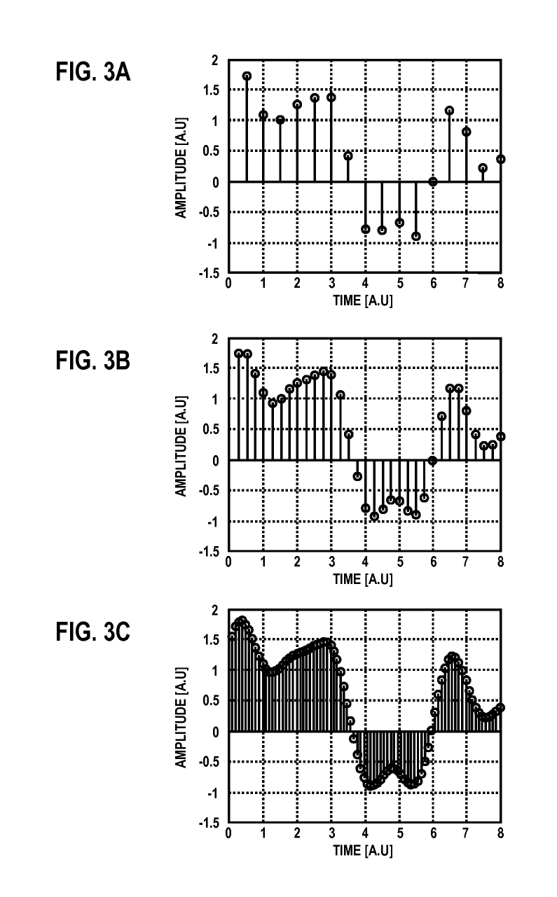

FIG. 3 shows an illustrative example of the sub-rate sampled receiver: FIG. 3(a) shows the directly obtained samples, whereas less than one sample per symbol slot is obtained. FIGS. 3(b) and 3(c) show two up sampling results—a two-fold up-sampling, yielding a single sample per symbol slot, and four-fold up-sampling, yielding two samples per symbol slot, respectively, as reconstructed by interpolation.

Accordingly, one aspect of the present invention is a method for communication receiver design that relies on a sampling rate that is lower than the transmitted symbol rate comprising the following steps:

(1) undersampling with respect to the transmitted symbol rate, performed by a receiver in receiving information;

(2) performing up-sampling of the received information at a receiver, employing interpolation relying on digital signal processing, up to at least the symbol rate; and

(3) passing the up-sampled information to remaining elements of a communication system detection chain in the receiver.

The method can employ a sampling rate that is a variable sampling rate. The transmitter can comprise: (i) a source input information stream; (ii) a pre-coder; and (iii) a means for pulse shaping. Typically, the transmitter and receiver are operationally connected by a channel to transmit under-sampled information from the transmitter to the receiver. The receiver can comprise: i) means for response shaping and/or adjustment; (ii) a sampler; (iii) an analog-to-digital converter; (iv) optionally, an equalizer for mitigating channel impairment; (v) an information-retrieving equalizer; (vi) a decoder; and (vii) means for transmitting the output information stream.

Interpolation can be performed by the steps of:

(1) performing fast or discrete Fourier transform on a block of directly obtained samples;

(2) padding the transformed samples with zero values above the highest frequency content in the Fourier transform domain; and

(3) performing inverse Fourier transformation on a zero-padded version of the Fourier transform domain sample set to arrive at the up-sampled version.

The number of padded zeroes can be determined by the desired level or ratio of up-sampling. Alternatively, interpolation can be performed by several techniques, including spline interpolation, polynomial interpolation, wavelet transform techniques, or lookup tables.

In an alternative, up-sampling can be performed by a properly weighted interpolation of the samples.

Another aspect of the present invention is a method for communication receiver design that relies on a sampling rate that is lower than the transmitted symbol rate comprising the following steps:

(1) undersampling with respect to the transmitted symbol rate, performed by a receiver;

(2) retrieving the information from the undersampled data by an information-retrieving equalizer, operating on a higher level symbol alphabet or a more complex structure; and

(3) passing the said retrieved information to remaining elements of a communication system detection chain.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### Advantages of the Invention

The present invention provides a system for transmitting information at a reduced sampling rate (a subrate). This requires lower power utilization and provides easier practical implementation while retaining the capability of retrieving the full information transmitted without losing or distorting any of the information. The systems and the methods of the present invention are effective at higher transmission speeds and even at higher symbol rates.

The present invention possesses industrial applicability as a system for transmitting information at a subrate and as a method for use of the system to transmit information at a subrate.

The method claims of the present invention provide specific method steps that are more than general applications of laws of nature and require that those practicing the method steps employ steps other than those conventionally known in the art, in addition to the specific applications of laws of nature recited or implied in the claims, and thus confine the scope of the claims to the specific applications recited therein. The method steps require the use of specific hardware and involve specific processes involving the hardware that generate a change in physical state of the hardware.

The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein.

It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. The disclosures of all articles and references, including patent publications, are incorporated herein by reference.

What is claimed is:

1. A method for communication receiver design that relies on a sampling rate that is lower than the transmitted symbol rate comprising the following steps:
(a) undersampling with respect to the transmitted symbol rate, performed by a receiver in receiving information;
(b) performing up-sampling of the received information at a receiver, employing interpolation relying on digital signal processing, up to at least the symbol rate; and
(c) passing the up-sampled information to remaining elements of a communication system detection chain in the receiver.

2. The method of claim 1 that employs a sampling rate that is a variable sampling rate.

3. The method of claim 1 wherein the transmitter comprises: (i) a source input information stream; (ii) a pre-coder; and (iii) a means for pulse shaping.

4. The method of claim 1 wherein the transmitter and receiver are operationally connected by a channel to transmit bandwidth constrained information from the transmitter to the receiver.

5. The method of claim 1 wherein the receiver comprises: (i) means for response shaping and/or adjustment; (ii) a sampler; (iii) an analog-to-digital converter; (iv) optionally, an equalizer for mitigating channel impairment; (v) an information-retrieving equalizer; (vi) a decoder; and (vii) means for transmitting the output information stream.

6. The method of claim 1 wherein interpolation is performed by the steps of:
(a) performing fast or discrete Fourier transform on a block of directly obtained samples;
(b) padding the transformed samples with zero values above the highest frequency content in the Fourier transform domain; and
(c) performing inverse Fourier transformation on a zero-padded version of the Fourier transform domain sample set to arrive at the up-sampled version.

7. The method of claim 6 wherein the number of padded zeroes is determined by the desired level or ratio of up-sampling.

8. The method of claim 1 wherein interpolation is performed by spline interpolation.

9. The method of claim 1 wherein interpolation is performed by polynomial interpolation.

10. The method of claim 1 wherein interpolation is performed by wavelet transform techniques.

11. The method of claim 1 wherein interpolation is performed by lookup tables.

12. The method of claim 1 wherein up-sampling is performed by a properly weighted interpolation of the samples.

13. A method for communication receiver design that relies on a sampling rate that is lower than the transmitted symbol rate comprising the following steps:
(a) undersampling with respect to the transmitted symbol rate, performed by a receiver;
(b) retrieving the information from the undersampled data by an information-retrieving equalizer, operating on a higher level symbol alphabet or a more complex structure; and
(c) passing the said retrieved information to remaining elements of a communication system detection chain.
